(19) United States
(12) Patent Application Publication
(10) Pub. No.: US 2018/0338434 A1
(43) Pub. Date: Nov. 29, 2018

(54) Manual Flush Drip Emitter

(71) Applicant: Rain Bird Corporation, Azusa, CA (US)

(72) Inventor: John James Wlassich, Pasadena, CA (US)

(21) Appl. No.: 15/985,944

(22) Filed: May 22, 2018

Related U.S. Application Data
(60) Provisional application No. 62/510,152, filed on May 23, 2017.

(51) Int. Cl. A01G 25/02

(52) U.S. Cl. CPC A01G 25/023; A01G 2025/006

(57) ABSTRACT

There is provided an on-line manual flush drip emitter. The emitter uses a diaphragm to provide pressure compensation. A plunger runs through an outlet of the emitter and is connected to the diaphragm. The plunger may be manually forced to push against the diaphragm to disengage it from a pressure compensating tortuous path and allow the water to flush debris from the tortuous path, and ultimately exit the emitter to the outside environment.

### CROSS-REFERENCE TO RELATED APPLICATIONS

This application claims benefit of U.S. Provisional Application No. 62/510,152, filed May 23, 2017, which application is hereby incorporated herein by reference in its entirety.

### FIELD

The subject matter is directed to drip emitters and, more particularly, to drip emitters with manual flushing capability.

### BACKGROUND

Irrigation systems are used to provide controlled watering to vegetation zones and specific plants. There are various types of irrigation emission devices that can be used in irrigations systems. One type of emitter is an on-line drip emitter. An on-line drip emitter attaches onto the outside of a supply line and converts high pressure flow in a supply line to a low pressure, drip-like emission. Exemplary flow rates for drip emission can be in the range of 0.5 to 24.0 gallons per hour.

An irrigation system may include many drip emitters attached at selected positions along the length of a supply line to deliver irrigation water to a large number of specific points, including directly to a plurality of individual plants.

On-line emitters may become clogged over time from debris, such as sand or dirt. Blockage in the emitter may be due to debris contaminating the water of the supply line and entering in the emitter, or from debris falling into the emitter from the outside environment. It would be beneficial to be able to manually flush the emitters and expel debris.

### DESCRIPTION OF THE DRAWINGS

FIG. 1 is a side elevational view of an on-line drip emitter embodying features of the present invention;

FIG. 2 is an exploded view of the drip emitter of FIG. 1;

FIG. 3 is a central cross-section view of the emitter of FIG. 1; and

FIG. 4 is a plan view of the emitter of FIG. 1 with its cover and first and second diaphragms removed.

### DESCRIPTION OF PREFERRED EMBODIMENTS

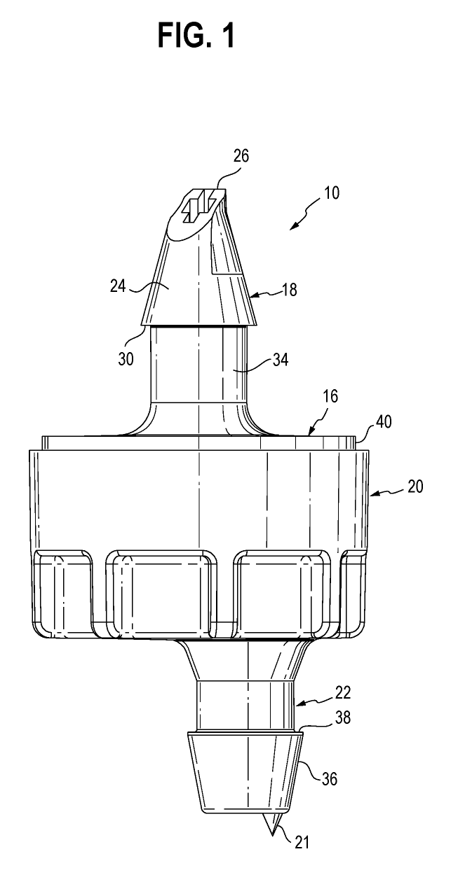

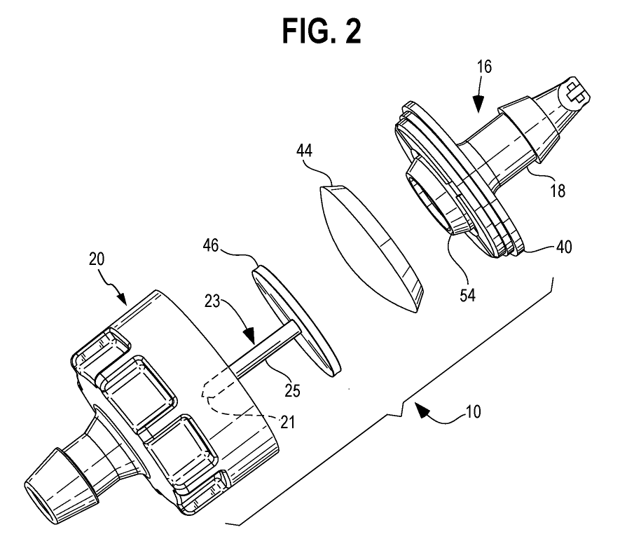

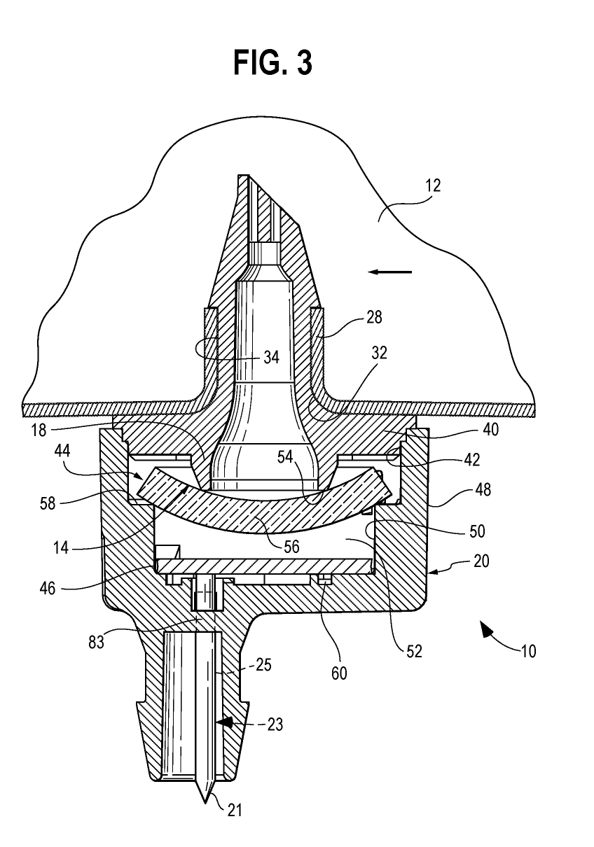

With reference to FIGS. 1-3, there is illustrated an on-line, manual flush drip emitter 10 that can be mounted to a supply line 12 to deliver irrigation water at a low volume, substantial trickle or drip flow rate. The drip emitter 10 includes a plunger 23 (FIG. 3) to allow for the emitter 10 to be manually flushed in the event of debris blockage, or simply as a precautionary measure before actual blockage may occur. Drip emitters, in general, are designed to slow the rate of water flowing through an irrigation supply line to create a slow, gentle drip of water to the outside vegetation. However, over time, the supply line 12 may be contaminated with debris, such as algae and sand, and small bits of debris in the water may enter into the emitter 10 and potentially clog the emitter 10. An operator may push on the plunger 23 which results in exposing small passages in the emitter and a faster flow of water through the emitter 10 and over such small passages, thereby releasing and expelling debris caught in the emitter 10.

The drip emitter 10 includes a cover 16 with an inlet tube 18 and a body 20 with an outlet tube 22. The inlet tube 18 terminates with a barb 24 with a penetrating edge 26 that assists to puncture a sidewall 28 of the supply line 12 for press-on puncture type attachment to the supply line 12. In some cases, the supply line 12 has been pre-punctured with a smaller hole using a puncture tool. The barb 24 includes a step 30 that prohibits the barb 24 from releasing from the supply line 12. The supply line 12 defines a hole 32 through which the inlet tube 18 extends into, and the material defining the hole 32 of the supply line seals against a wall 34 of the inlet tube 18.

The outlet tube 22 also terminates with a barb 36. The outlet tube 22 can extend into a tube that can be used to further locate emission of the water from the emitter 10 for precise irrigation. The barb 36 includes an annular edge 38 that bites into the tube to prevent the tube from releasing from the outlet tube 22.

The cover 16 includes a disc-shaped base 40 that can be press-fit into an open end 42 of the body 20. The body 20 and cover 16 can be secured together such as by welding or use of an adhesive. The body 20 and cover 16 can be plastic molded components.

The emitter 10 includes a first diaphragm 44 that cooperates with the cover 16 to provide the check valve 14 to prevent leakage from the emitter 10 between irrigation events. The emitter 10 also includes a second diaphragm 46 that cooperates with the body 20 to provide pressure compensation. The pressure compensation ensures that the emission rate of the emitter 10 is consistent when the pressure in the supply line 12 fluctuates.

The plunger 23 has a smaller diameter than the diameter of the outlet tube 22 and extends through the outlet tube 22. The plunger 23 is comprised of a cylindrical stem 25 and a tip 21. The cylindrical stem 25 may be solid or hollow. The stem 25 of the plunger 23 is preferably attached perpendicularly to the bottom surface of the diaphragm 46. The tip 21 extends beyond the outlet of the outlet tube 22 for manual engagement. In an alternative configuration, the plunger 23 may be truncated so as to have a tip 21 slightly shorter than the outlet tube 22. The tip 21 has a pointed configuration; however, the tip 21 may also take on a rounded, domed, or any blunt shaped configuration. The tip 21 is pressed to move the second diaphragm 46 to assist in flushing debris from the emitter 10, as discussed further herein. The plunger 25 may be made of a sufficiently rigid material, such as plastic or metal that maintains its form while displacing the diaphragm 46.

The body 20 has a generally cup-shaped form with an upstanding wall forming a cylindrical exterior wall 48 and a cylindrical, stepped interior wall 50. The body 20 and the cover 16 combine to define an interior chamber 52. The check valve 14 resides in the interior chamber 52 and includes a valve seat 54 at an end of the inlet tube 18 in the interior chamber 52 and the first diaphragm 44. The valve seat 54 can have an inner diameter larger than the inner diameter of the inlet tube 18 outside the interior chamber 52. The check valve 14 is shown in the closed position with a center region 56 of the first diaphragm 44 engaged with the valve seat 54.

The first diaphragm 44 is circular in shape and rests on an annular ledge 58 formed about a perimeter of the interior chamber 52 by the stepped interior wall 50. The first diaphragm 44 is positioned along the interior chamber 52 defined by the ledge 58 and has a thickness such that the valve seat 54 causes the first diaphragm 44 to bow downstream in the interior chamber 52 to exert a predetermined amount of sealing pressure on the valve seat 54 for holding back water in the supply line 12 between irrigation events. The sealing pressure could be in a range of about 3 to 6 psi and preferably about 4.3 psi. The sealing pressure could be higher or lower depending on the preloaded pressure of the first diaphragm 44 and depending on the resiliency of the material of the first diaphragm 44 material. The first diaphragm 44 could be made of silicone and have a thickness of 0.060 inches.

The material hardness and thickness dimension could be changed to alter the hold-back capability of the check valve. For instance, if the thickness of the first diaphragm 44 is reduced, and with everything else remaining the same, the check valve 14 would have a lower hold-back pressure. On the other hand, if the thickness is increased, then the hold-back pressure would be higher. The same could be done with the material hardness and/or a combination of material hardness and thickness. Also, the interference between the first diaphragm 44 and valve seat 54 could be changed by altering the length that the inlet tube 18 extends into the interior chamber 52 to either increase (longer extension) or decrease (shorter extension) the hold-back pressure. Further, the inner diameter of the inlet tube 18 can be changed to manipulate the response time of the first diaphragm 44. The inner diameter could be made larger to increase opening response time, or smaller to decrease opening response time. When the supply pressure exceeds the sealing pressure, such as during an irrigation event, the water pushes the first diaphragm 44 away from the valve seat 54, and water is allowed into the interior chamber 52. Still further, in alternative embodiment, the emitter 10 may not include the first diaphragm 44, therefore the emitter 10 includes the second diaphragm 46 and no check valve.

The second diaphragm 46 is located downstream of the first diaphragm 44. The second diaphragm 46 lays on a bottom of the interior chamber 52 and is not structurally restricted from upstream movement. The supply pressure in the interior chamber 52 causes the second diaphragm 46 to seat on the bottom of the interior chamber 52. The body 20 defines a tortuous path 60 at the bottom of the interior chamber 52. The tortuous path 60 reduces the inlet pressure of the water flowing into the emitter 10. Water pressure in the interior chamber 52 acts on the second diaphragm 46 to cause the second diaphragm 46 to seal the tortuous path 60, as discussed further below. The stem 25 of the plunger 23 may be attached to the diaphragm 46.

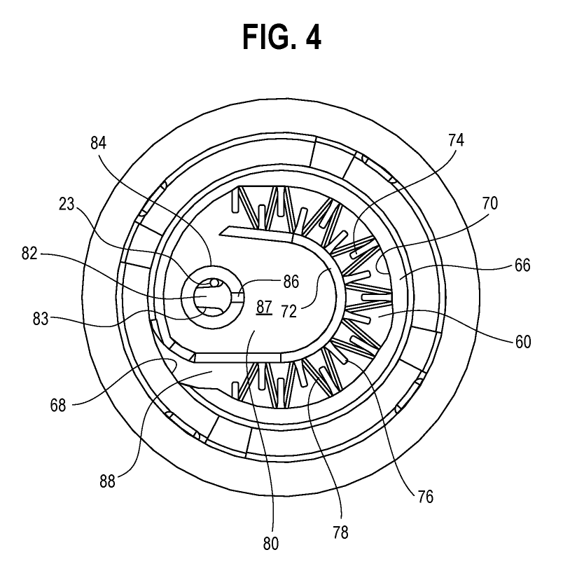

As shown in FIG. 4, the second diaphragm 46 rests on an annular ledge 66 about the perimeter of the interior chamber 52. The ledge 66 includes a break that forms a passage 68 for water to flow past the second diaphragm 46 and to the tortuous path 60. The tortuous path 60 extends about the bottom of the body 20 in a generally circular or U-shaped pattern. The tortuous path 60 consists of an outer wall 70 (which forms the annular ledge 66 on its top) and an inner wall 72 spaced inward of the outer wall 70. It also includes an outer set of baffles 74 extending inward from the outer wall 70 and an inner set of baffles 76 extending outward from the inner wall 72. The baffles of the outer and inner sets 74,76 are staggered relative to one another such that the inner baffles 76 are directed between the outer baffles 74. The baffle sets 74,76 cross a center line through the tortuous path 60. The baffles 74,76 cause the water to flow in a direction changing laterally back-and-forth, resulting in velocity reduction and turbulence to achieve a substantial pressure reduction.

A series of weirs 78 also extends from a base of the outer baffles 74 to a base of the inner baffles 76. The baffles 74,76 all have the same height, and the weirs 78 are shorter than the baffles 74,76. The weirs 78 cause the water flowing through the tortuous path 60 to be deflected vertically, thereby imparting an up-and-down direction change to the flow. The combined effects of the baffles 74,76 and the weirs 78 create a three-dimensional tortuous flow path which is of relatively large cross-sectional size and wherein the water repeatedly changes direction back-and-forth and up-and-down to result in a substantial and relatively increased pressure reduction over a relatively short channel length.

The tortuous path 60 terminates to allow water to flow into an inner discharge chamber 80. An outlet 82 leading to the outlet tube 22 is located in the inner discharge chamber 80. The outlet 82 includes a raised circular boss 84 projecting upwardly from a floor 87 of the inner discharge chamber 80. The boss 84 defines an upwardly open discharge metering groove 86 that extends across a wall of boss 84 for discharge flow of the water from the discharge chamber 80 to the outlet 82 of the emitter 10.

As water flows into the interior chamber 52, the second diaphragm 46 seals on the outer and inner walls 70, 72 of the tortuous path 60. As the water pressure increases further in the interior chamber 52, the second diaphragm 46 moves towards the boss 84 and its metering groove 86. This movement can cause access to the outlet 82 to be reduced. Eventually, if the pressure increases enough, the second diaphragm 46 will engage the boss 84, and the water will flow only through the metering groove 86. With further increase in pressure, the effective cross-sectional size of the metering groove 86 may be reduced as the second diaphragm 46 is pressure-forced partially into the metering groove 86. The emitter 10 thus provides for pressure compensation by varying the access to the outlet 82 and the effective size of the metering groove 86 as a function of inlet pressure, to achieve a substantially constant discharge outlet flow over a range of typical water supply pressures. Moreover, due to the increased pressure drop created by the three-dimensional tortuous path 60, the discharge metering groove 86 can be of relatively large size, yet still provide the desired pressure regulation function while further reducing the possibility of clogging during use.

The second diaphragm 46 is disc-like in shape and could be made of silicone and have a thickness of 0.029 inches. The material and thickness could be altered to change the pressure compensation range.

During an irrigation event, water flows through the supply line 12 and into the drip emitter 10 through the inlet tube 18. The supply pressure exceeds the threshold of the check valve 14 and causes the first diaphragm 44 to move away from the valve seat 54. The water then flows past the first diaphragm 44 and into the interior chamber 52 between the first and second diaphragms 44, 46. The pressure of the water in the interior chamber 52 seals the second diaphragm 46 against the tortuous path 60. Water flows through the break 68 about the second diaphragm 46 and to an inlet 88 of the tortuous path 60, through the tortuous path 60 and out through outlet 82 and the outlet tube 22. The second diaphragm 46 will operate to compensate for pressure fluctuations in the supply pressure. The combination of the pressure reduction and pressure compensation enables the flow emitted from the emitter to be in the desired amount. For example, the desired amount could be in the range of about 0.5 to 2 gallons per hour. Upon conclusion of the irrigation event, the supply water will become virtually unpressurized, and the check valve 14 will seal against the valve seat 54 and prevent water in the supply line 12 from draining out through the drip emitter 10.

In the event of debris blockage, or simply as a precautionary measure, the emitter 10 may be manually flushed. As discussed above, the stem 25 of the plunger 23 may engage or be attached to the bottom surface of the diaphragm 46, and the plunger tip 21 extends slightly beyond the outlet tube 22. The plunger 23 is in a perpendicular, or generally perpendicular, orientation to the diaphragm 46. Pressure in the chamber 52 causes the diaphragm 46 to seat on the bottom of the inner chamber 52 against the tortuous path 60; however, when a force is applied to the plunger 23 by manually pushing on the plunger tip 21 (for example, by pushing it with a finger), the plunger 23 pushes the diaphragm 46 up off the annular ledge 66 and from the bottom of the inner chamber 52. The stem 25 is connected to the diaphragm 46 at an off-axis point, therefore when the plunger 23 pushes on the diaphragm 46, the diaphragm is tilted with respect to the bottom of the inner chamber 52. As a result, the water in the chamber 52 that would normally flow past the second diaphragm 46 and into the tortuous path 60 via the passages 68, can proceed directly into the bottom of the inner chamber 52. The velocity and volume of the water allowed to flow past the tilted diaphragm 46 evacuates debris that may be trapped in the inner chamber 52, including in-between the tortuous path 60 and the diaphragm 46, or in the outlet tube 22. It also will be able to flush debris trapped in the metering groove 86. The difference in the diameter of the plunger 23 and the diameter of the outlet tube 22 is larger than the size of typical debris, allowing the water (that may contain debris) exiting the inner chamber 52 to flow past the plunger 23 and not be impeded by the plunger 23 as it is flushed from the emitter 10 through the outlet tube 22.

As shown in FIG. 3, outlet tube 22 includes a bridge 83 that extends across the outlet 82 to prevent debris from entering the chamber 52. The stem 25 may extend from the second diaphragm 46 to pass the bridge 83 on one side. The stem would have a cross-sectional dimension less than that of the opening portion of the outlet 82 on the stem side of the bridge 83 so that the stem 25 can operate freely and this portion of the passage would not be entirely obstructed. The stem 25 could be guided by the bridge 83. Also, the portion of the outlet 82 on the other side of the bridge 83 would be completely unobstructed. Alternatively, there could be sufficient friction between the stem 25 and the passage past the bridge 83 so that the friction engagement with the stem 25 holds the stem 25 in the outlet tube 22. Thus, the stem 25 would not have to be secured to the second diaphragm 46 but only would need to be able to engage the second diaphragm 46 for flushing. In a further alternative, the outlet 82 could be formed without the bridge 83 or any other type of obstruction. In this situation, the stem 25 could extend from the center of the outlet tube 22 or any other location depending on where it is attached to the second diaphragm 46.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A drip emitter comprising:
a body defining an inlet, an outlet and an interior chamber;
a tortuous path defined by the body;
a diaphragm in the interior chamber and being capable of sealing the tortuous path upon being subject to a pressure; and
a plunger being engageable with a bottom surface of the diaphragm, the plunger capable of moving the diaphragm away from at least a portion of the tortuous path upon activation by an external force to the plunger.

2. The drip emitter of claim 1, wherein the plunger includes a stem.

3. The drip emitter of claim 1, wherein the stem is of a smaller diameter than an outlet tube of the drip emitter.

4. The drip emitter of claim 2, wherein the stem includes an actuator end that extends beyond the outlet tube of the emitter.

5. The drip emitter of claim 1, wherein the diaphragm has a center and the plunger engages the diaphragm at an off-center location of the diaphragm.

6. The drip emitter of claim 1, wherein the stem extends generally perpendicularly from the diaphragm.

7. The drip emitter of claim 1, wherein the plunger is attached to the diaphragm.

8. The drip emitter of claim 1, wherein the outlet comprises a partial obstruction to prevent debris from entering the interior chamber.

9. The drip emitter of claim 8, wherein the plunger extends along one side of the partial obstruction.

10. The drip emitter of claim 1, further comprising a check valve having a closed position to prevent fluid from entering the interior chamber when a pressure for such fluid is below a predetermined level.

11. The drip emitter of claim 10, wherein the check valve includes a second diaphragm.

12. The drip emitter of claim 1, wherein the inlet defines a seat in the interior chamber for the second diaphragm to sit on when in the closed position.
